(19) United States
(12) Patent Application Publication
(10) Pub. No.: US 2013/0250547 A1
(43) Pub. Date: Sep. 26, 2013

(54) LIGHTING CONVERSION APPARATUS

(71) Applicants: Cheryl Engstrom, Bothell, WA (US); Scott Bell, Nampa, ID (US)

(72) Inventors: Cheryl Engstrom, Bothell, WA (US); Scott Bell, Nampa, ID (US)

(73) Assignee: BURNES BRIGHTER IDEAS, LLC, Atlanta, GA (US)

(21) Appl. No.: 13/459,807

(22) Filed: Apr. 30, 2012

Related U.S. Application Data
(60) Provisional application No. 61/613,058, filed on Mar. 20, 2012.

(51) Int. Cl. F21V 33/00

(52) U.S. Cl. 362/95

(57) ABSTRACT

A lighting conversion apparatus provided which converts a recessed light into a non-recessed light. A threaded electrical contact is designed to screw into the existing socket of a recessed light. The threaded electrical contact is connected to a socket extension, which is in turn connected to a socket extension base. A canopy is attached to the socket extension base, and fixtures extend from the canopy. The socket extension and socket extension base may telescope allow for shortening of the distance between the canopy and the threaded electrical contact. When installed, the canopy may therefore rest flush with the ceiling surrounding the recessed light hole.

### CROSS-REFERENCE TO RELATED APPLICATION

The present application claims priority to and incorporates herein by reference U.S. Provisional Patent Application Ser. No. 61/613,058 filed on Mar. 20, 2012.

### FIELD OF THE INVENTION

The present invention relates to a lighting conversion apparatus, and more precisely to a screw-in apparatus for converting a recessed light into a non-recessed light.

### BACKGROUND OF INVENTION

A recessed light is installed into a hollow opening in a ceiling, rather than a standard light fixture which hangs below the ceiling. When installed, the recessed light appears as a light emanating from a hole in the ceiling. The bulb used in recessed lighting screws into the socket, which is recessed into the hollow opening so that the bulb sits near the level of the ceiling.

However, once installed, an end-user has few options for removing a recessed light. To uninstall a recessed light, the housing must be removed and the hole in the ceiling must be (at least partially) repaired. Further, recessed lights do not always provide the appropriate amount or directionality of light. Recessed lights generally provide “down lighting,” which can produce certain negative aesthetic effects. For example, placing a recessed light too far from a wall can result in a “scalloping” shadow effect in which the downwardly directed light does not reach the top portion of a wall. Down lighting can also result in other strange shadow effects on objects and faces, if not supplemented with other levels and layers of light.

Specific advantages and features of the present invention will be apparent from the attached drawings and the description of an illustrative embodiment of the present invention.

### SUMMARY OF INVENTION

A lighting conversion apparatus is designed to convert a recessed light into a non-recessed light. A threaded electrical contact is designed to screw into the existing socket of a recessed light. The socket is connected to a socket extension, which is in turn connected to a socket extension base. A canopy is attached to the socket extension base, and fixtures extend from the canopy.

In operation, the socket extension is fully extended from the socket extension base. The threaded electrical contact is then screwed into the existing socket of a recessed light. Once screwed in, the lighting conversion apparatus may be entirely supported by the socket/electric contact connection. The threaded electrical contact can draw electricity from the existing socket, and provide same to the fixtures through standard electrical wiring. Such wiring is preferably contained within the socket extension/socket extension base, and preferably extends into and through the canopy to the fixtures.

However, not all recessed lights are the same depth. The socket of one recessed light may be closer to or further from the ceiling as compared to any other recessed light. Therefore, either the socket extension preferably includes at least one row of teeth. The socket extension base preferably includes at least one finger which engages with the teeth. Alternatively, the socket extension base may include at least one row of teeth while the socket extension includes at least one finger.

Once the threaded electrical contact is engaged with the socket, the extended socket extension and socket extension base, when fully extended, serve to position the canopy away from the ceiling. To place the canopy adjacent the ceiling, a user presses upwardly on the canopy, causing the socket extension to be retracted into the socket extension base, effectively “telescoping” the socket extension into the socket extension shaft, until the canopy is flush with the ceiling. As the socket extension collapses into the socket extension base, the at least one finger allows the teeth to pass in only one direction, ratcheting along each successive tooth. However, the finger does not allow the teeth to pass back in the other direction, thereby holding the socket extension and socket extension base in a truncated position.

It is noted that in order to uninstall the lighting conversion apparatus, it need merely be unscrewed from the socket. The fingers may have tabs which allow the fingers to be manually pulled away from the teeth to allow the socket extension to be fully extended again. By unscrewing the apparatus and re-extending the socket extension from the socket extension base, the apparatus is essentially reset so that it can be reused. In this manner, the light conversion apparatus is adjustable to substantially any recessed lighting depth. The canopy can be pushed flush with the ceiling, and the fingers/teeth of the socket extension/socket extension base hold the canopy in place. The weight of the light conversion apparatus may be about 5 pounds.

Once installed, a variety of light weight decorative shades may be installed using a center stem system similar to what is standard in the lighting industry, as would be understood by one of ordinary skill in the art. A shade in fabric, glass or acrylic may be designed and used. In addition, in one embodiment, a fixture may have functional and decorative directional lighting built into the apparatus. This design allows for a variety of shades and decorative lighting fixtures to be installed to the apparatus.

### DESCRIPTION OF THE DRAWINGS

FIG. 1 is a perspective view of an example lighting conversion module according to an example embodiment.

FIG. 2 is a longitudinal cross-sectional perspective view of the example lighting conversion module of FIG. 1, as installed in a recessed light.

FIG. 3 is a longitudinal cross-sectional view of a socket extension and socket extension base according to an example embodiment.

FIG. 4 is a longitudinal cross sectional view of an example lighting conversion module with a center stem, according to an example embodiment.

It should be understood that the present drawings are not necessarily to scale and that the embodiments disclosed herein are sometimes illustrated by fragmentary views. In certain instances, details which are not necessary for an understanding of the present invention or which render other details difficult to perceive may have been omitted. It should also be understood that the invention is not necessarily limited to the particular embodiments illustrated herein. Like numbers utilized throughout the various figures designate like or similar parts or structure.

### DETAILED DESCRIPTION

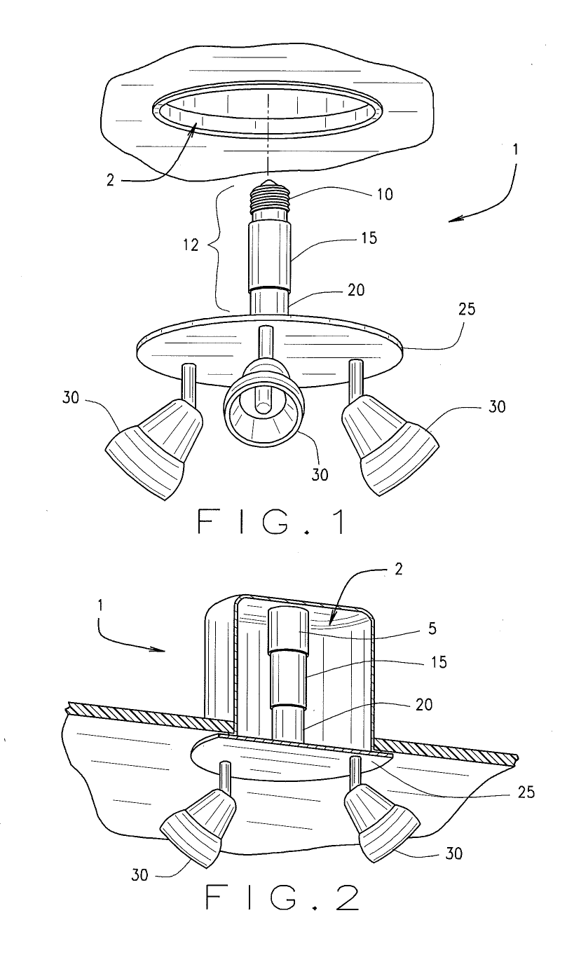

Referring now to the drawings and more particularly to FIGS. 1 and 2, a lighting conversion module 1 is shown, which is configured for use with an existing recessed light housing 2 with an existing socket 5 (best seen in FIG. 2). Lighting conversion module 1 includes a threaded electrical contact 10 at the distal end of an adjustable shaft 12. The adjustable shaft 12 is comprised of socket extension 15 and socket extension base 20. Socket extension base 20 is connected to a canopy 25, which is in turn connected to one or more lighting fixtures 30.

In operation, the adjustable shaft 12 is positioned within the existing recessed light housing 2. The threaded electrical contact 10 is then engaged with and screwed into socket 5. The mechanical connection between socket 5 and electrical contact 10 preferably supports the weight of the lighting conversion module 1. The engagement of the socket 5 and the electrical contact 10 also provides electrical power to the lighting conversion module 1 from socket 5.

Once the electrical contact 10 is engaged with socket 5, the adjustable shaft 12 extends downwardly therefrom, and canopy 25 is connected to the bottom of the adjustable shaft 12. Adjustable shaft 12 is preferably extendable to a length at which the canopy 25 is positioned at a level which is at least adjacent the bottom of the surrounding ceiling More preferably, adjustable shaft 12 is extendable to a length at which the canopy 25 is positioned below the level of the ceiling. Thus, in a preferred embodiment, an initial gap is present between the canopy 25 and the ceiling when the electrical contact 10 is engaged with socket 5.

In order to reduce or eliminate the gap between the canopy 25 and the ceiling, socket extension base 20 may at least partially slide into (or “telescope into”) socket extension 15 to shorten the length of adjustable shaft 12. Alternatively, socket extension 15 may telescope into socket extension base 20. Such telescoping action may be initiated merely by a user pressing upwardly on the canopy 25 or light fixture 30. The canopy 25 may thereby by positioned to abut or nearly abut the ceiling surrounding the existing recessed light housing 2 such that canopy 25 covers the hole in the ceiling created by the existing recessed light housing 2.

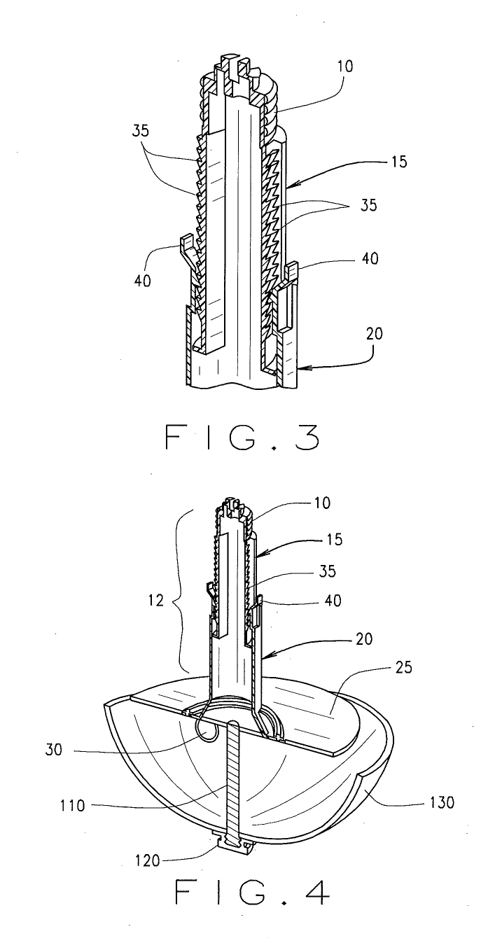

As shown in FIG. 3, in order to maintain the shortened length of adjustable shaft 12, socket extension 15 may include at least one row of teeth 35 extending longitudinally along the socket extension 15. Socket extension base 20 may have a corresponding number of fingers 40 for engagement with the at least one row of teeth 35. As will be understood, socket extension 15 may alternately include at least one finger 40 while socket extension base 20 may alternately include at least one row of teeth 35.

FIG. 3 illustrates an embodiment of adjustable shaft 12 with two rows of teeth 35 and two fingers 40. Fingers 40 and teeth 35 are cooperatively size, shaped and positioned to allow movement of the socket extension 15 and socket extension base 20 relative to one another in one direction, but to prevent such movement in the other direction. As pressure is applied to canopy 25 and adjustable shaft 12 becomes shorter, fingers 40 and teeth 35 slide past one another such that socket extension base 20 can telescope into the socket extension 15 (or vice versa). However, movement of the socket extension 15 and socket extension base 20 in the opposite direction is prevented by the engagement of finger(s) 40 with teeth 35. Thereby, finger(s) 40 and teeth 35 prevent the extension of adjustable shaft 12, unless separated from one another by a user.

Lighting conversion module 1 may be uninstalled from the existing recessed light housing 2 merely by unscrewing electrical contact 10 from socket 5. Additionally, a finger 40 may be shaped to allow the fingers 40 to be manually pulled away from the teeth 35 to allow the adjustable shaft 12 to be fully extended again. By unscrewing the apparatus 1 and re-extending the socket extension 15 relative to the socket extension base 20, the apparatus 1 is essentially reset so that it can be reused. In this manner, the light conversion apparatus 1 is adjustable to substantially any recessed lighting depth. The canopy 25 can be pushed flush with the ceiling, and the fingers 40 and teeth 35 of the socket extension 15 and socket extension base 20 hold the canopy 25 in place. The weight of the light conversion apparatus may be about 5 pounds.

Standard electrical wires, as would be known in the art, preferably connect the electrical contact 10 with light fixture(s) 30. Such electrical wires (not shown) are preferably run from electrical contact 10, through a cavity in adjustable shaft 12, through canopy 25 and to light fixture(s) 30. However, such electrical wires may be external to the adjustable shaft 12 and/or canopy 25. Light fixture(s) 30 may include at least one directional spotlight, or other types of lighting fixtures.

In an alternative embodiment shown in FIG. 4, a lighting conversion module includes a center stem 110 which extends downwardly from canopy 25. Center stem 110 allows a shade 130 to be held in place via decorative nut 120. Shade 130, as shown in FIG. 4 is a glass dome, though it is recognized that shade 130 may be made of any suitable material, may be any color or combination of colors, may have a desired size or shape, or a variety of sizes and shapes, etc.

Thus, there have been shown and described embodiments of a novel lighting conversion module 1. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A lighting conversion module comprising:
a selectively telescoping shaft having a distal end and a proximal end;
an electrical contact attached to the distal end of said telescoping shaft, said electrical contact configured for mechanical and electrical engagement with a light socket;
a canopy attached to the proximal end of the telescoping shaft;
at least one light fixture attached to the canopy; and
electrical wiring connecting the at least one light fixture with the electrical contact so as to provide power to the at least one light fixture from a light socket when the electrical contact is engaged with a light socket.

2. The lighting conversion module of claim 1 wherein the selectively telescoping shaft includes a socket extension and a socket extension base, the socket extension being capable of selectively telescoping into a socket extension base.

3. The lighting conversion module of claim 2 wherein the socket extension includes at least one row of teeth and the socket extension base includes at least one finger for engagement with the at least one row of teeth, the engagement of the at least one finger with the at least one row of teeth allowing for selective telescoping of the socket extension into the socket extension base while preventing extraction of the socket extension from the socket extension base.

4. The lighting conversion module of claim 3 wherein the at least one finger includes a tab for manually releasing the at least one finger from the at least one row of teeth to permit the extraction of the socket extension from the socket extension base.

5. The lighting conversion module of claim 2, wherein the socket extension base includes at least one row of teeth and the socket extension includes at least one finger for engagement with the at least one row of teeth, the engagement of the at least one finger with the at least one row of teeth allowing for selective telescoping of the socket extension into the socket extension base while preventing extraction of the socket extension from the socket extension base.

6. The lighting conversion module of claim 5 wherein the at least one finger is sized and shaped to allow for manually releasing the at least one finger from the at least one row of teeth to permit the extraction of the socket extension from the socket extension base.

7. The lighting conversion module of claim 1 wherein the canopy is sized and shaped to cover an opening for a recessed light when installed.

8. The lighting conversion module of claim 1 wherein the at least one lighting fixture includes at least one directional spotlight.

9. The lighting conversion module of claim 1 further including a center stem extending from the canopy for selectively retaining a decorative shade.

10. The lighting conversion module of claim 1 wherein the electrical wiring extends from the electrical contact to the at least one light fixture through a cavity in the telescoping shaft.

11. A light conversion module comprising:
an electrical contact configured for mechanical and electrical engagement with a light socket;
a socket extension;
a socket extension base configured for selective longitudinal movement relative to the socket extension such that said socket extension base is capable of telescoping into said socket extension, said socket extension being connected to the electrical contact;
a canopy attached to said socket extension base;
at least one light fixture attached to the canopy; and
electrical wiring housed within said socket extension and socket extension base for connecting the electrical contact with the at least one lighting fixture.

12. The lighting conversion module of claim 11 wherein the socket extension includes at least one row of teeth and the socket extension base includes at least one finger for engagement with the at least one row of teeth, the engagement of the at least one finger with the at least one row of teeth allowing for selective telescoping of the socket extension base into the socket extension while preventing extraction of the socket extension base from the socket extension.

13. The lighting conversion module of claim 12 wherein the at least one finger includes a tab for manually releasing the at least one finger from the at least one row of teeth to permit the extraction of the socket extension base from the socket extension.

14. The lighting conversion module of claim 11, wherein the socket extension base includes at least one row of teeth and the socket extension includes at least one finger for engagement with the at least one row of teeth, the engagement of the at least one finger with the at least one row of teeth allowing for selective telescoping of the socket extension base into the socket extension while preventing extraction of the socket extension base from the socket extension.

15. The lighting conversion module of claim 14 wherein the at least one finger includes a tab for manually releasing the at least one finger from the at least one row of teeth to permit the extraction of the socket extension base from the socket extension.

16. The lighting conversion module of claim 11 wherein the canopy is sized and shaped to cover an opening for a recessed light when installed.

17. The lighting conversion module of claim 11 wherein the at least one lighting fixture is a directional light.

18. The lighting conversion module of claim 11 further including a center stem extending from the canopy for selectively retaining a decorative shade.

19. The lighting conversion module of claim 11 wherein the electrical wiring extends from the electrical contact to the at least one light fixture through a cavity in the telescoping shaft.
